(19) United States
(12) Patent Application Publication
(10) Pub. No.: US 2014/0351013 A1
(43) Pub. Date: Nov. 27, 2014

(54) ANCILLARY SERVICE BID GENERATION SYSTEMS AND METHODS

(71) Applicant: HONEYWELL INTERNATIONAL INC., Morristown, NJ (US)

(72) Inventors: Steve Gabel, Golden Valley, MN (US); George Bell, Morristown, NJ (US); Paul Lipkin, Morristown, NJ (US); Earl Gray, Morristown, NJ (US); John Hurd, Morristown, NJ (US)

(73) Assignee: Honeywell International Inc., Morristown, NJ (US)

(21) Appl. No.: 13/902,377

(22) Filed: May 24, 2013

(51) Int. Cl. G06Q 30/02; G06Q 50/06

(52) U.S. Cl. CPC G06Q 30/0206; G06Q 50/06
USPC 705/7.31

(57) ABSTRACT

Ancillary service bid generation systems and methods are described herein. One example of a method for ancillary service bid generation includes quantifying an electric demand for a number of electrical devices, determining an electric demand reduction capability of the number of electrical devices for a number of event scenarios, and preparing an ancillary service bid based on the electric demand reduction capability of the number of electrical devices.

### GOVERNMENT RIGHTS

The subject matter of this disclosure was made with government support under Contract Number W912HQ-12-C-0030. Accordingly, the U.S. Government has certain rights to subject matter disclosed herein.

### TECHNICAL FIELD

The present disclosure relates to ancillary service bid generation systems and methods.

### BACKGROUND

An electric grid operator can monitor and control the operation of an electrical power transmission system (e.g., electrical grid, etc.) to ensure its reliability. The grid operator can schedule generation and demand side resources (to balance supply and demand) as needed, to ensure the reliability of the grid.

The grid operator can also administer an open wholesale electricity market (e.g., energy market, electric power market, etc.), which can include generation as well as demand side resource providers. This electricity market can include bids and contracts for ancillary services (short term use of generation or demand side resources for balancing and reliability purposes).

Energy providers, electric utility companies, and demand response aggregators can participate as scheduling coordinators or scheduling entities in the electricity market, serving as intermediaries offering the use of demand side resources owned by electric customers.

### BRIEF DESCRIPTION OF THE DRAWINGS

FIG. 1 illustrates an example of an ancillary service bid generation environment in accordance with one or more embodiments of the present disclosure.

FIGS. 2A and 2B illustrate an example of a user interface for ancillary service bid generation in accordance with one or more embodiments of the present disclosure.

FIG. 3 illustrates an example method for ancillary service bid generation in accordance with one or more embodiments of the present disclosure.

FIG. 4 illustrates a block diagram of an example of a computing device in accordance with one or more embodiments of the present disclosure.

### DETAILED DESCRIPTION

Ancillary service bid generation systems and methods can include quantifying an electric demand for a number of electrical devices, determining an electric demand reduction capability of the number of electrical devices for a number of event scenarios, and preparing an ancillary service bid based on the electric demand reduction capability of the number of electrical devices.

The electric demand can be a quantity of electric power that is consumed when operating an electrical device. For example, a heating and air conditioning unit can operate utilizing a particular amount of kilowatts (kW). The particular amount of kilowatts can vary based on an operation level (e.g., high, medium, low, etc.). For example, a heating, ventilation, and air conditioning (HVAC) system can utilize (e.g., require) a greater amount of kilowatts when operating at a high level compared to operating at a lower level.

The electric demand reduction capability can be a quantity of power (e.g., electricity, electricity in kilowatts) that can be reduced by lowering the operation level of a number of electrical devices. For example, lowering the operation level of a lighting system (e.g., light display, office lights, plurality of lights, etc.) can lower the amount of kilowatts used by the lighting system. In this example, the amount of kilowatts not used by the lighting system after lowering the operation level can be a quantity of electric demand reduction that can be offered in an ancillary services bid.

The ancillary service bid can be prepared to provide information to a grid operator, through an electric provider or other intermediary. The information can include a number of event scenarios (e.g., level of electric demand, etc.) with an electric demand reduction that can be provided by a demand side resource upon a request. For example, the ancillary service bid can include a quantity of electric demand that can be reduced for a high, medium, and/or low demand level event scenario.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of devices” can refer to one or more devices.

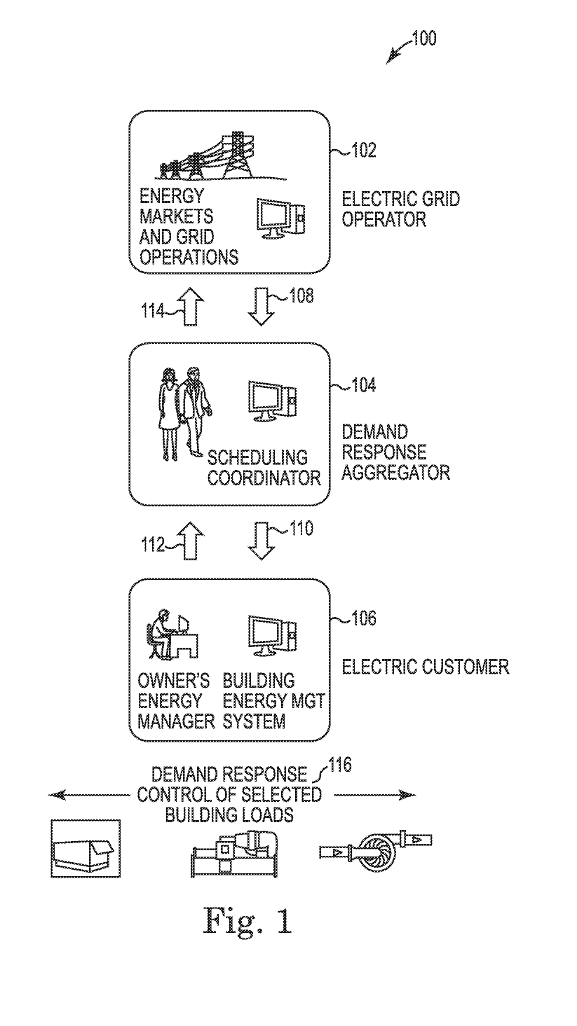

FIG. 1 illustrates an example of an ancillary service bid generation environment 100 in accordance with one or more embodiments of the present disclosure. The environment 100 can include an electric grid operator 102, a demand response aggregator 104 (e.g., scheduling coordinator, scheduling entity, energy provider, electrical provider, intermediary, etc.), and/or an electric customer 106 with a number of electrical devices 116.

The electric grid can have increases and decreases in the electric demand. When there are increases in the electric demand, the electric grid operator 102 can utilize a short term resource that can generate the necessary increase in demand without causing failures within the electric grid. Another way to accommodate for increases in the electric demand can be the utilization of demand side resources.

The electric grid can have short term imbalances between electric supply and demand. When these imbalances occur, the electric grid operator 102 can utilize generation resources (e.g. power plants, renewable energy sources, etc.) to balance supply and demand to ensure the reliability of the electric grid. In addition, the electric grid operator 102 can utilize demand side resources (e.g., electric devices 116, etc.) to reduce electric demand to balance supply and demand of the electric grid.

Demand side resources can be electrical devices (e.g., lighting, heating and air conditioning units, elevators, etc.) that can be turned off and/or altered to lower power consumption to reduce electric demand on the grid. Demand side resources can be greater utilized by the electric grid operator 102 if the demand side resources can be predictably turned off and/or altered to a lower power consumption. For example, the electric grid operator 102 can send a signal to indicate a need for a reduction in electric demand and the electric customer 106 can alter a user's electricity consumption by altering the settings of a number of electrical devices 116 to reduce the demand on the electric grid.

Generating ancillary service bids can increase predictability of demand side resources by quantifying the electric demand reduction capabilities for a particular electric customer. The electric demand reduction capabilities can be subject to a number of parameters (e.g., time of day, day of the week, ambient temperature, etc.). For example, the electric demand reduction capabilities can be subject to parameters such as the time of day. In this example, the electric demand reduction capabilities can be different for different times of a particular day. In another example, the electric demand reduction capabilities can include parameters such as outdoor temperature. In this example, the electric demand reduction capabilities of an electrical device (e.g., heating and air conditioning unit, HVAC, etc.) can be different for different temperatures. That is, the HVAC system can have a greater electric demand reduction capability when the exterior temperature is within a particular range (e.g., 90° F.-100° F.).

Data can be collected from the number of electrical devices 116 by a building electric management system (BEMS) to determine a quantity of power consumed and/or electric demand for each of the number of electrical devices 116 at various times during a particular period (e.g., day, week, etc.) and also include a corresponding temperature at the various times during the particular period. For example, a HVAC system at an office building can have a greater electric demand during business hours compared to non-business hours and also have a greater demand on days with relatively high temperatures compared to days with lower temperatures. The BEMS can be a computing device that is connected to a number of electrical devices within a building or campus (e.g., multiple buildings) to control and/or monitor the electrical devices. For example, the BEMS can monitor and/or control a building's ventilation system, lighting system, power system, fire system, security system, elevators, and/or heating and air conditioning system (e.g., HVAC system).

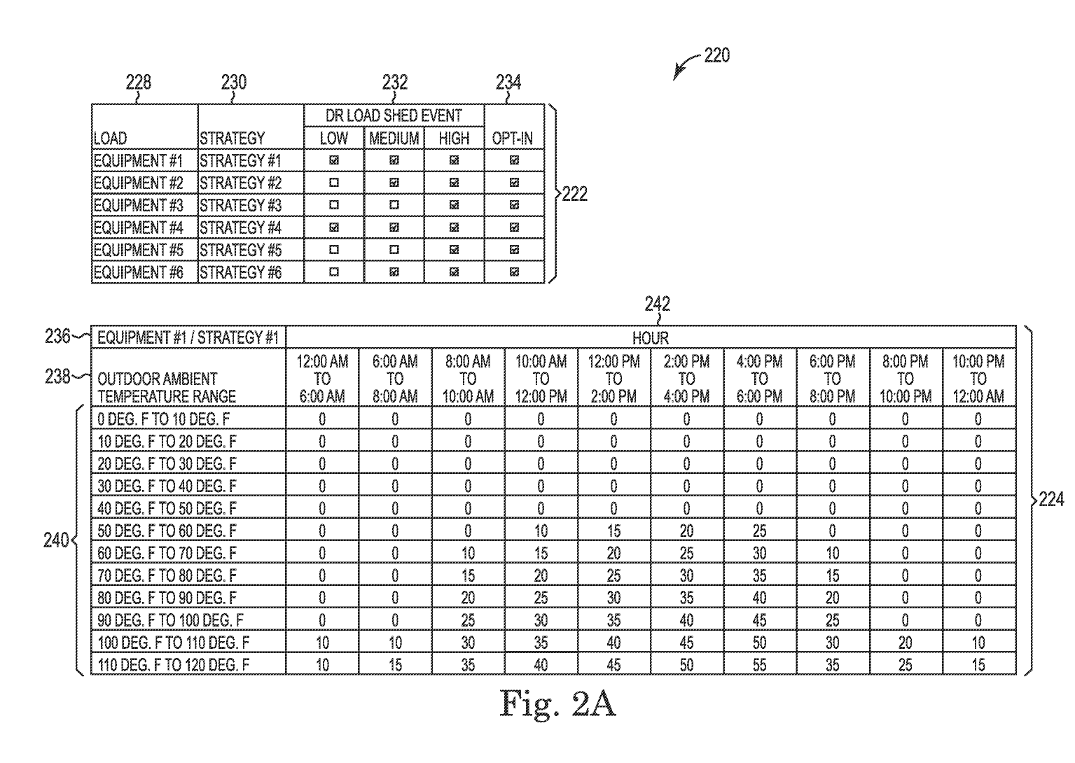

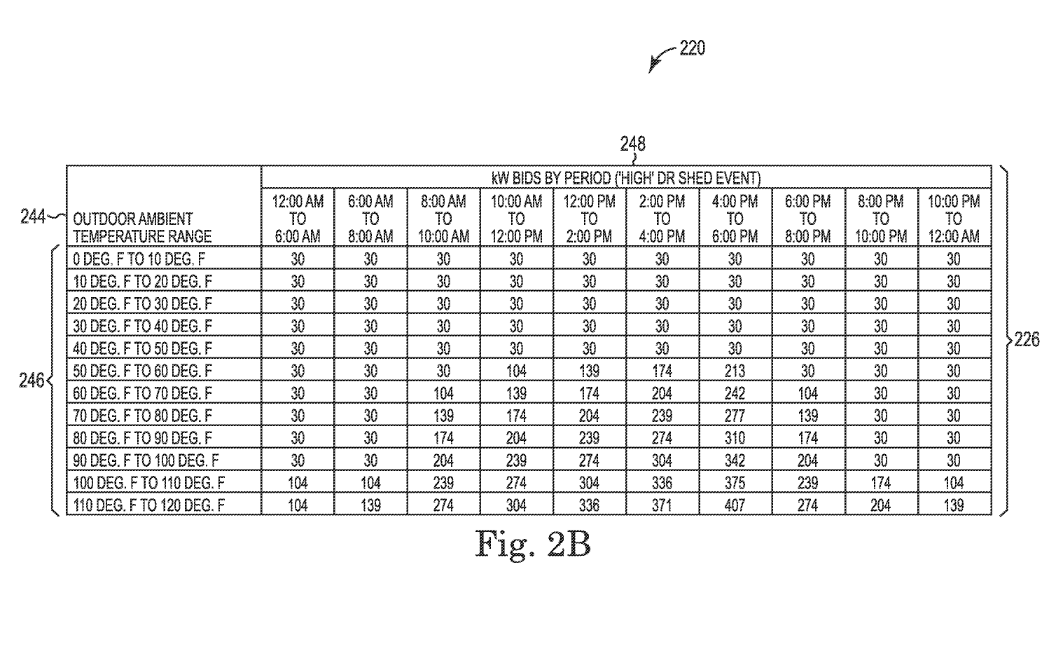

The data that is collected can be utilized to generate a table (e.g., demand reduction table 224 as referenced in FIG. 2, etc.) for each of the number of electrical devices 116 that specifies and/or quantifies electric demand reduction capabilities for periods of a day (e.g., 12:00 am to 6:00 am, 2:00 pm to 4:00 pm, etc.) and a temperature range (e.g., 0° Celsius (C) to 10° C., 70° F. to 80° F., etc.) for each of the periods of the day. The table (e.g., demand reduction table 224 as referenced in FIG. 2) can represent a model (e.g., mathematical model, representation of equipment behavior, etc.) of reduction capabilities for electrical devices. For example, the HVAC system can have a table generated to display the HVAC system's electric demand reduction capabilities for multiple time periods and a corresponding exterior temperature for each of the time periods.

A table (e.g., ancillary service bid table 226 as referenced in FIG. 2, etc.) can be generated to include a number of electrical devices that corresponds to an event scenario. For example, the electrical device can be a HVAC system. The event scenario can be an electric demand reduction range that is predefined by the electric provider 102 and/or the demand response aggregator 104. For example, the demand response aggregator 104 can have predetermined electric demand reduction ranges for “high”, “medium”, and/or “low” electric demand reduction event scenarios.

In each of the electric demand event scenarios there can be a designated quantity of demand reduction that can be utilized by the energy provider when an electric demand event scenario occurs. For example, a “high” electric demand event scenario can have a corresponding designated quantity of demand reduction for a particular electrical device. In this example, the designated quantity of electric demand reduction can be a quantity of power the electric customer 106 is prepared to lower for the particular electrical device when the “high” electric demand event scenario occurs.

The tables for each of the number of electrical devices can be utilized together (e.g., added together) to generate (e.g., prepare) an ancillary service bid. The ancillary service bid can include the designated quantity of electric demand that the electric customer 106 can lower in response to a particular event scenario. For example, the ancillary service bid can include that the electric customer 106 can lower the electric demand of an electrical device by 100 kW. In addition, the ancillary service bid can include a total quantity of electric that the electric customer 106 can lower for a particular event scenario. For example, the ancillary service bid can include that the electric customer 106 can lower a total electric demand by 1000 kW. In this example, the electric customer 106 can have a first electrical device that can be lowered by 400 kW and a second electrical device that can be lowered by 600 kW.

The ancillary service bid can be generated on a periodic basis (e.g., monthly, weekly, yearly, etc.). For example, the quantity that an electric customer 106 can lower for a particular electrical device can change for a number of reasons (e.g., seasonal, updated electrical devices, etc.). The ancillary service bid can be automatically generated by a BEMS on the periodic basis and/or when there has been a change in the electric demand reduction capability. For example, the BEMS can receive electric demand information from the number of electrical devices 116 and utilize the electric demand information to determine if a new (e.g., updated) ancillary service bid is necessary. That is, the electric demand reduction capability may have changed beyond a predetermined threshold and it is determined that a new ancillary service bid will be generated.

The ancillary service bid can also be generated on a schedule provided by the demand response aggregator 104. The schedule can provide dates and/or times for the electric customer 106 to provide the ancillary service bid. After an ancillary service bid is generated by the electric customer 106 (e.g., BEMS, etc.), the ancillary service bid can be sent to a scheduling coordinator 104 at 112. The ancillary service bid can be converted to a bid file (e.g., electronic file, computing file, etc.) and sent electronically to the scheduling coordinator 104 at 112. The bid file can be in a designated format determined by the demand response aggregator 104 and/or electric grid operator 102.

The demand response aggregator 104 can receive ancillary service bids from a plurality of electric customers that can include the electric customer 106. The scheduling coordinator 104 can receive a plurality of ancillary service bids and consolidate the plurality of ancillary service bids to provide the electric grid operator 102 with a total quantity of electric demand reduction for the plurality of electric customers. The demand response aggregator 104 can send the total quantity of electric demand reduction capability as an ancillary service bid to the electric grid operator 102 via 114. The total quantity of electric demand reduction capability can be for each event scenario.

The electric grid can experience a particular event scenario and the electric grid operator 102 can send a notification to the demand response aggregator via 108. For example, a particular event scenario can relate to a need for short-term electric demand reduction that can be provided by demand side resources (e.g., electrical devices 116, etc.). For example, the electric grid can need a short-term reduction in electric demand. In this example, the electric grid operator 102 and/or the energy provider 104 can determine that the need for a short-term electric demand reduction qualifies as a “medium” event scenario. The electric grid operator 102 can send a notification to the demand response aggregator 104 indicating that an event scenario has occurred via 108. For example, the electric grid operator 102 can determine that an event scenario is occurring and can send a notification to the demand response aggregator 104 with information relating to the electric demand reduction needs of the electric grid operator 102.

The demand response aggregator 104 can utilize the received notifications from the electric grid operator 102 and the demand response aggregator 104 can send a notification to the electric customer 106 via 110. The notification to the electric customer 106 can include the electric demand event scenario that is occurring on the grid.

The notification to the electric customer 106 can include instructions to lower the electric demand of the number of electrical devices 116 based on an event scenario. For example, the notification to the electric customer 106 can include an event scenario that corresponds to a quantity of electric demand that the electric customer 106 can lower by altering settings of the number of electrical devices 116.

The electric customer 106 can have predetermined settings for the number of electrical devices 116 for each of a number of event scenarios. The predetermined settings can be settings to alter the operation of the number of electrical devices 116 to reduce the electric demand to the received event scenario level. For example, the electric customer 106 can have predetermined settings for the number of electrical devices 116 that corresponds to a “low” event scenario. In this example, the predetermined settings that correspond to the event scenario can lower the electric demand for the number of electrical devices 116. In another example, the predetermined settings that correspond to the event scenario can turn off and/or cut the power to the number of electrical devices 116 in order to lower the electric demand.

The notification sent to the electric customer 106 can include computer readable instructions (CRI) that can be executed by a computing device (e.g., BEMS) connected to the electrical devices 116 of the electric customer 106. For example, the notification can include CRI that when executed by a BEMS alter the settings of the electrical devices 116 based on the predetermined settings that correspond to a particular event scenario. In another example, the notification can include the particular event scenario that is occurring and the predetermined setting changes that correspond to the received event scenario can be stored on the computing device and executed when the notification is received.

The ancillary service bid generation environment 100 can be utilized to generate ancillary service bids for the electric customer 106 and provide electric demand reduction capabilities (e.g., a quantity of electric demand reduction available) for demand side resources. In addition, the ancillary service bid generation environment 100 can enable the electric customer 106 to quickly change settings that correspond to an event scenario upon receiving a notification.

FIGS. 2A and 2B illustrate an example of a user interface 220 for ancillary service bid generation in accordance with one or more embodiments of the present disclosure. FIGS. 2A and 2B show an example of a user interface 220 and subsequent tables that can be based, in part, on the selection of the user interface 220. For example, the user interface 220 can include a selection table 222, a demand reduction table 224, and/or an ancillary service bid table 226.

The selection table 222 can include a plurality of equipment (e.g., electrical devices, electronic devices, etc.) that can draw an electrical load under the load column 228. For example, Equipment #1 can represent an HVAC system. In another example, Equipment #2 can represent a lighting system. The plurality of equipment can be connected to a computing device (e.g., BEMS, etc.).

The selection table 222 can include a strategy column 230 that can include a reduction strategy for each of the plurality of equipment within a particular area (e.g., building, campus, etc.). For example, the reduction strategy column 230 can include information relating to the reduction strategy for the particular equipment. In this example, the information relating to the reduction strategy can include an overall rating and/or plan for reducing the electric demand for the corresponding equipment.

The selection table 222 can include an event column 232 (e.g., demand response (DR) load shed event column). The event column 232 can consist of sub-columns. For example, the event column 232 can consist of a “low”, “medium”, and/or a “high” sub-column to describe a type of event. A user (e.g., BEMS operator, building manager, etc.) can select and/or de-select a number of event scenarios (e.g., low, medium, high, etc.) for each piece of equipment. By selecting one or more of the event scenarios the user can determine which of the number of event scenarios to include in the ancillary service bid. For example, a user can select “medium” and “high” event scenarios for “Equipment #2”. That is, a number of settings for “Equipment #2” can be altered to lower the electric demand of the “Equipment #2” when a “medium” and “high” event scenario occurs. In this same example, if the “low” event scenario is not selected or de-selected, the number of settings for the “Equipment #2” may not be altered to lower the electric demand of the “Equipment #2”.

The selection table 222 can include an opt-in column 234. The opt-in column 234 can be utilized to select and/or de-select the number of equipment from the ancillary service bid. For example, the user can select the check box that corresponds to “Equipment #2” and based on the selection, the “Equipment #2” with the event scenarios can be included in the ancillary service bid. Alternatively, in another example, the user can de-select a check box that corresponds to “Equipment 3” and the event scenarios that correspond to “Equipment 3” may not be included in the ancillary service bid.

A demand reduction table 224 can be generated for each of the number of equipment (e.g., electrical devices, “Equipment #1, etc.) listed in the selection table 222. The demand reduction table 224 can have a description column 236. The description column 236 can include a name and/or description of the equipment that is represented by the demand reduction table 224. For example, the description column 236 can include a name of the equipment (e.g., HVAC system, lighting system, Equipment #1, etc.). In this example, the description column 236 can also include a number of control settings (e.g., operating strategy) that is represented in the demand reduction table 224.

The demand reduction table 224 can include the outdoor ambient temperature range column 238. The outdoor ambient temperature range column 238 can include a number of temperature ranges 240. The number of temperature ranges 240 can include ranges within a particular minimum temperature and a particular maximum temperature based on a location of the equipment. The demand reduction table 224 can include an hour column 242. The hour column can include a number of time periods (e.g., period of hours within a day period, etc.). The time periods may not include the same quantity of hours. For example, a first time period can include six hours of time during a particular day and a second time period can include two hours of time during the particular day.

The demand reduction table 224 can include an electric demand reduction for each hour and corresponding temperature range. The electric demand reduction can be represented in kilowatts. For example, the electric demand reduction for “Equipment #1” within the time period of 12:00 pm to 2:00 pm at an ambient temperature within 50° Fahrenheit (F) to 60° F. can be 15 kW. The demand reduction table 224 can represent a particular time period (e.g., 5 day week, 2 day week, etc.). For example, the demand reduction table 224 can represent a time period that includes the days of a work week for a particular building. In this example, the time period can be a five day work week (e.g., Monday-Friday).

The ancillary service bid table 226 can be generated as a sum of the demand reduction contributions of each of the number of equipment and can be generated for each of the number of event scenarios. For example, an ancillary service bid table 226 can be generated for a “low”, “medium”, and “high” event scenario. The ancillary service bid table 226 can represent a “high” event scenario and can be described in a title column 248.

The ancillary service bid table 226 can include an outdoor ambient temperature range column 244, an hour column, and a number of temperature ranges column 246 that can correspond to the columns provided in the demand reduction table 224 for each piece of equipment. The ancillary service bid table 226 can include a bid for an electric demand reduction for each of the time periods and corresponding temperature ranges. For example, the bid for an electric demand reduction within the time period of 12:00 pm to 2:00 pm at an ambient temperature within 50° F. to 60° F. can be 139 kW.

The ancillary service bid table 226 can be sent as the ancillary service bid to an electric provider and/or other intermediary such as a demand response aggregator. In some examples, the ancillary service bid table 226 can be converted to an electronic document prior to sending the ancillary service bid.

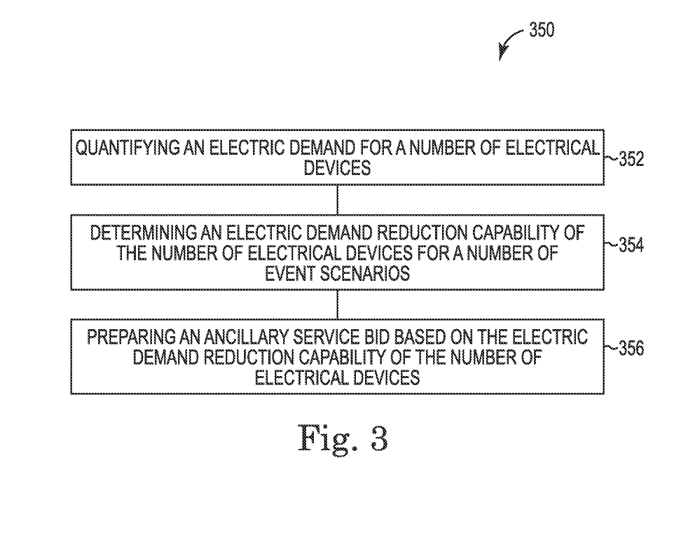

FIG. 3 illustrates an example method 350 for ancillary service bid generation in accordance with one or more embodiments of the present disclosure. The method 350 can be utilized to generate ancillary service bids to an electric provider. In response to providing the ancillary service bids to the electric provider, the energy provider can send notifications to inform the electric customer to alter an electric demand as specified in the ancillary service bids provided.

At box 352, the method 350 can include quantifying an electric demand for a number of electrical devices. Quantifying the electric demand can include determining a quantity of electric demand that the number of electrical devices can reduce during a particular time period. For example, data can be collected by a building electric management system (BEMS) that relates to the electric demand and/or demand reduction capability of the number of electrical devices. The data collected by the BEMS can be utilized to generate a number of tables. The tables can be generated utilizing an ambient exterior temperature. For example, the table can represent an electric demand reduction capability over a period of time and at various ambient temperatures.

At box 354, the method 350 can include determining an electric demand reduction capability of the number of electrical devices for a number of event scenarios. The electric demand reduction capability of the number of electrical devices can be a quantity of electric demand that can be reduced by altering a number of settings of the electrical devices.

In some examples, altering the number of settings can include turning off and/or eliminating the electricity to the electrical devices. In another example, altering the number of settings can include limiting the capability of the number of electrical devices. Limiting the capabilities of the electrical devices can vary based on the type of device. For example, limiting the capability of the electrical devices can include lowering a fan speed of a HVAC system.

Determining the electric demand reduction capability of the number of electrical devices can include determining a quantity of electric demand that can be reduced for each of the number of electrical devices. For example, it can be determined that an HVAC system can have a greater quantity of electric demand that can be reduced during particular times (e.g., hours of the day, during business hours, etc.) and/or at particular temperature ranges. In this example, it can be determined that the fan of the HVAC system can be lowered more significantly (e.g., greater quantity of electric demand reduced) during business hours and at temperatures that are within a predetermined range (e.g., 90° F.-100° F.).

Determining the electric demand reduction capability can include generating an electric demand reduction table as described herein. For example, an electric demand reduction table can be generated for each of the number of electric devices. The electric demand reduction table, as described herein, can be utilized to generate a number of ancillary service bid tables corresponding to each of the event scenarios (e.g., “low”, “medium”, and/or “high”).

At box 356, the method 350 can include preparing an ancillary service bid based on the electric demand reduction capability of the number of electrical devices. Preparing the ancillary service bid can include generating the ancillary service bid table as described herein. For example, the electric demand reduction table for each of the number of electric devices can be used to generate an ancillary service bid table. In this example, the ancillary service bid tables can be generated for each of a number of event scenarios.

The ancillary service bid can be sent to an electric provider and/or to a demand response aggregator. Providing the ancillary service bid to the electric provider can specify the electric demand reduction capability for a particular electric customer and/or user. The electric provider can utilize the ancillary service bids to determine demand side resource capabilities. For example, the electric provider can utilize the information supplied within the ancillary service bids and send notifications to users when the demand side resources are needed to balance the electric grid.

The settings selected in a selection table (e.g., selection table 222 referenced in FIG. 2), as described herein, should be consistent with the equipment control or operating strategy selections that are programmed into the BEMS. Having the settings selected in the selection table consistent with the equipment control can ensure that a customer (e.g., electric customer 106 referenced in FIG. 1) response to an event notification from a scheduling coordinator (e.g., scheduling coordinator 104 referenced in FIG. 1) will produce the desired amount of electric demand reduction (e.g. as offered in the ancillary services bid).

The method 350 can include receiving a notification that a particular event scenario has occurred. The notification can be an electronic message received from the demand response aggregator. The notification can include an event scenario that is occurring.

Receiving the notification can result in automatically implementing the electric demand reduction that corresponds to the event scenario within the notification. The notification can initiate the electric demand reduction of the number of electrical devices. For example, the notification can be received by the BEMS and upon receiving the notification the BEMS can implement the demand reduction for the number of electrical devices corresponding to the event scenario included within the notification.

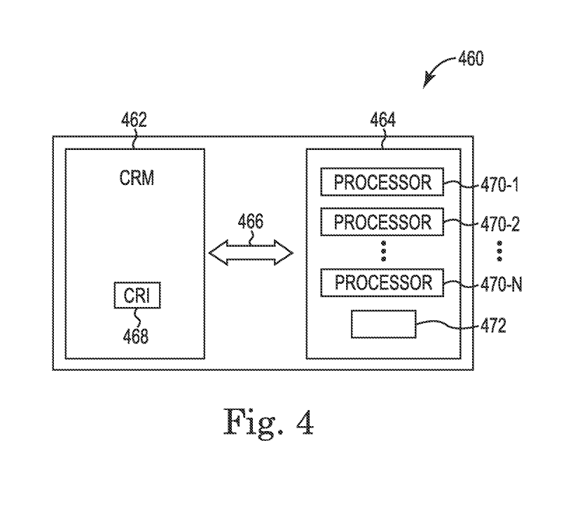

FIG. 4 illustrates a block diagram of an example of a computing device 460 in accordance with one or more embodiments of the present disclosure. The computing device 460 can include a communication interface (e.g., wireless network interface controller, IEEE 802.11 adapters, etc.) for receiving electronic data (e.g., wireless data, etc.). The communication interface can be integrated in the computing device 460 and/or be an external card.

The computing device 460, as described herein, can also include a computer readable medium (CRM) 462 in communication with processing resources 470-1, 470-2, . . . , 470-N. CRM 462 can be in communication with a device 464 (e.g., a Java® application server, among others) having processor resources 470-1, 470-2, . . . , 470-N. The device 464 can be in communication with a tangible non-transitory CRM 462 storing a set of computer-readable instructions (CRI) 468 (e.g., modules) executable by one or more of the processor resources 470-1, 470-2, . . . , 470-N, as described herein. The CRI 468 can also be stored in remote memory managed by a server and represent an installation package that can be downloaded, installed, and executed. The device 464 can include memory resources 472, and the processor resources 470-1, 470-2, . . . , 470-N can be coupled to the memory resources 472.

Processor resources 470-1, 470-2, . . . , 470-N can execute CRI 468 that can be stored on an internal or external non-transitory CRM 462. The processor resources 470-1, 470-2, . . . , 470-N can execute CRI 468 to perform various functions. For example, the processor resources 470-1, 470-2, . . . , 470-N can execute CRI 468 to perform a number of functions (e.g., determine an electric demand reduction capability of a number of electrical devices for a number of event scenarios, perform control or operating strategies that can reduce the electric demand of a number of electrical devices, etc.). A non-transitory CRM (e.g., CRM 462), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), as well as other types of computer-readable media.

The non-transitory CRM 462 can also include distributed storage media. For example, the CRM 462 can be distributed among various locations.

The non-transitory CRM 462 can be integral, or communicatively coupled, to a computing device, in a wired and/or a wireless manner. For example, the non-transitory CRM 462 can be an internal memory, a portable memory, a portable disk, or a memory associated with another computing resource (e.g., enabling CRIs to be transferred and/or executed across a network such as the Internet).

The CRM 462 can be in communication with the processor resources 470-1, 470-2, . . . , 470-N via a communication path 466. The communication path 466 can be local or remote to a machine (e.g., a computer) associated with the processor resources 470-1, 470-2, . . . , 470-N. Examples of a local communication path 466 can include an electrical bus internal to a machine (e.g., a computer) where the CRM 462 is one of volatile, non-volatile, fixed, and/or removable storage medium in communication with the processor resources 470-1, 470-2, . . . , 470-N via the electrical bus. Examples of such electrical buses can include Industry Standard Architecture (ISA), Peripheral Component Interconnect (PCI), Advanced Technology Attachment (ATA), Small Computer System Interface (SCSI), Universal Serial Bus (USB), among other types of electrical buses and variants thereof.

The communication path 466 can be such that the CRM 462 is remote from the processor resources e.g., 470-1, 470-2, . . . , 470-N, such as in a network relationship between the CRM 462 and the processor resources (e.g., 470-1, 470-2, . . . , 470-N). That is, the communication path 466 can be a network relationship. Examples of such a network relationship can include a local area network (LAN), wide area network (WAN), personal area network (PAN), and the Internet, among others. In such examples, the CRM 462 can be associated with a first computing device and the processor resources 470-1, 470-2, . . . , 470-N can be associated with a second computing device (e.g., a Java® server).

As described herein, a “module” can include computer readable instructions (e.g., CRI 468) that can be executed by a processor to perform a particular function. A module can also include hardware, firmware, and/or logic that can perform a particular function.

As used herein, “logic” is an alternative or additional processing resource to execute the actions and/or functions, described herein, which includes hardware (e.g., various forms of transistor logic, application specific integrated circuits (ASICs)), as opposed to computer executable instructions (e.g., software, firmware) stored in memory and executable by a processor.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for ancillary service bid generation, comprising:
quantifying an electric demand for a number of electrical devices;
determining an electric demand reduction capability of the number of electrical devices for a number of event scenarios; and
preparing an ancillary service bid based on the electric demand reduction capability of the number of electrical devices.

2. The method of claim 1, wherein quantifying the electric demand for the number of electrical devices includes quantifying an electric usage for the number of electrical devices at each of the number of event scenarios.

3. The method of claim 1, wherein determining the electric demand reduction capability includes determining a demand response strategy for each of the number of event scenarios.

4. The method of claim 1, wherein quantifying the electric demand includes utilizing a time range and exterior ambient temperature.

5. The method of claim 1, comprising receiving a notification that a particular event scenario has occurred.

6. The method of claim 1, wherein the notification initiates the electric demand reduction of the number of electrical devices.

7. The method of claim 6, wherein receiving the notification results in implementing the electric demand reduction that corresponds to the notification.

8. A non-transitory computer readable medium, comprising instructions to:
determine an electric demand reduction capability of a number of electrical devices for a number of event scenarios;
quantify an electric demand reduction for the number of electrical devices at each of the number of event scenarios; and
prepare an ancillary service bid based on the electric demand reduction capability of the number of electrical devices, wherein the ancillary service bid includes a quantity of electric demand that can be reduced at each of the number of event scenarios.

9. The medium of claim 8, wherein the electric demand reduction capability is for a predetermined time period.

10. The medium of claim 8, comprising instructions to change the electric demand for the number of electrical devices to the electric demand reduction of a particular event scenario.

11. The medium of claim 10, wherein to change the electric demand includes altering an electric draw from the number of electrical devices.

12. The medium of claim 10, wherein to change the electric demand includes turning off a portion of the number of electrical devices.

13. The medium of claim 8, comprising instructions to send the ancillary service bid to an intermediary for processing.

14. The medium of claim 8, wherein to determine the electric demand reduction capability includes utilizing usage patterns of the number of electrical devices.

15. A system, comprising:
a computing device including instructions to:
receive an electric demand reduction capability of a number of electrical devices for a number of event scenarios;
quantify an electric demand for the number of electrical devices at each of the number of event scenarios;
prepare an ancillary service bid based on the electric demand reduction capability of the number of electrical devices;
receive a notification that a particular event scenario is occurring; and
alter the electric demand of the number of electrical devices to settings that correspond to the particular event scenario.

16. The system of claim 15, wherein the instructions to alter the electric demand of the number of electrical devices eliminates the power supply to a portion of the number of electrical devices.

17. The system of claim 15, comprising instructions to select a portion of the number of electrical devices to alter the electric demand for each of the number of event scenarios.

18. The system of claim 15, comprising instructions to prepare a table for each of the number of electrical devices that includes an electric demand for periods of the day and temperature ranges.

19. The system of claim 15, wherein each of the number of event scenarios includes an amount of demand reduction.

20. The system of claim 15, wherein a portion of the number of electrical devices are selected to be removed from the ancillary service bid for particular event scenarios.
